(19) United States
(12) Patent Application Publication
(10) Pub. No.: US 2006/0225532 A1
(43) Pub. Date: Oct. 12, 2006

(54) Cam mechanism for low vibration air-driven screwdriver

(75) Inventor: Tsuh Chang Lee, Lw Jou City (TW)

Correspondence Address: TROXELL LAW OFFICE PLLC, SUITE 1404, 5205 LEESBURG PIKE, FALLS CHURCH, VA, 22041, US

(73) Assignee: Mijy-Land Industrial Co., Ltd.

(21) Appl. No.: 11/092,877

(22) Filed: Mar. 30, 2005

(51) Int. Cl. F16H 53/00

(52) U.S. Cl. 74/567

(57) ABSTRACT

This invention related to an improved cam mechanism of low vibration air driven screwdriver, in particular, applicable to the clutch for the electric or pneumatic screwdriver in an effort to reduce the vibration to the minimum. The orbital surface of the cam body provides three segments of cyclic stroke, each stroke comprises the top dead point and the bottom dead point and each segment further contains four phases stroke, namely phase stroke A, phase stroke B, phase stroke C and phase stroke D. Each stroke of the orbital surface forms a recess for the catch ball to move. These two new designs are intended to reduce the vibration to the minimum and to cut the production cost in one way and to increase the friction area between the cam body and the ball so as to elongate the service life span in other way.

### BACKGROUND OF THE INVENTION

1. Field of the Invention

This invention concerns a novel design of the cam mechanism, best applicable to the electric or pneumatic screwdriver in an attempt to reduce the vibration to the minimum, to cut down the production and to elongate the service life span.

2. Description of the Prior Art

The cam mechanism of the clutch is commonly used in the electric or pneumatic screwdriver. The operational theory is that the catch ball in the lower clutch will rise from the bottom dead point to the top dead point along the orbital surface so as to activate the electrical or mechanism switch and to stop the power or air supply in an effort to control the torque of the screwdriver. When the torque is obtained, the torque spring will exert the pressure on the catch ball, the lower clutch and punch, the cam will fall from the top dead point to the bottom dead point, forming an 180° cycle. While the motor is running, the cam is forced to move and the catch ball begin to rotate, at this moment, the catch ball, being held by the pressure exerted by the torque spring, is unable to lower down unless the pushing force exercised by the cam is greater that the pressure exerted by the torque spring. While the cam is pressing the catch ball and the lower clutch, there generates a reaction. The coil action of the torque spring works as a brake to stop the motor running. The pressure the torque adjusting ring applies to the torque spring will induce the cam to produce a resistance in the wake of varying pressure the torque spring exerts; this is the way to gain the effective torque control.

There are two designs of the cam mechanism available. The first design is called the general purpose cam mechanism allowing 45 degree clockwise rotation and 45 degree reverse on the 90 degree orbit). It is further classified as one cam mechanism permits both clockwise and reverse rotation and other cam mechanism permits one direction rotation only. The merit of this design is low production cost and the demerit is high vibration.

The second design is an improved low vibration cam in which the reverse rotation is of considerably small angle. In practice, this cam is employed exclusively with the single rotation bearing. The major merits are low vibration and easy operation, but the demerit is that the special bearing is expensive to make.

Regardless which cam mechanism is employed, the design of the orbital surface and the stroke between the top dead point and the bottom dead point is not immaculate, when in bolt tightening operation, it as usual generate a relative counter moment which would finally injure the arm of the operator after long time operation.

Viewing from the above statement, the inventor has devoted for year the great efforts to study possible improvement and finally come up with this improved cam mechanism for the low vibration air-driven screwdriver.

### SUMMARY OF THE INVENTION

The main object is this invention is to provide an improved cam mechanism for using on the low vibration air-driven screwdriver, suitable to two rotation direction or single rotation direction with low production cost, less vibration and longer ser4vice life.

The improved cam mechanism as provided by this invention is appropriate for the electric and pneumatic screwdriver. The orbital surface of the cam body is designed with three segments, each segment contains a stroke from the top dead point to the bottom dead point and each stroke comprises four phases, namely the phase A, the phase B, the phase C and the phase D. Each stroke orbital surface provides curved recess for the catch ball to move along. These two new designs are intended to reduce the vibration to the minimum and to cut the production cost in one way and to increase the friction area between the cam body and the catch ball so as to elongate the service life span in other way.

The technical advantages, the structural features and the solid efficiency of this invention is explained in great detail with the aid of the embodiment as illustrated in the drawings attached,

### BRIEF DESCRIPTION OF THE DRAWINGS

FIG. 1 shows the 3-d appearance of the cam mechanism of this invention.

FIG. 2 show top view of the cam mechanism of this invention.

FIG. 3 shows extended diagram of the cam mechanism of this invention.

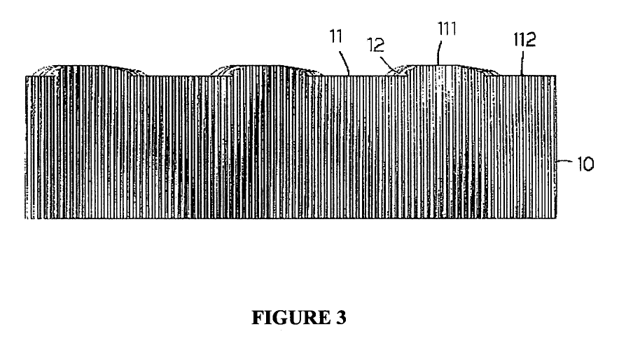

### DETAILED DESCRIPTION OF THE PREFERRED EMBODIMENT

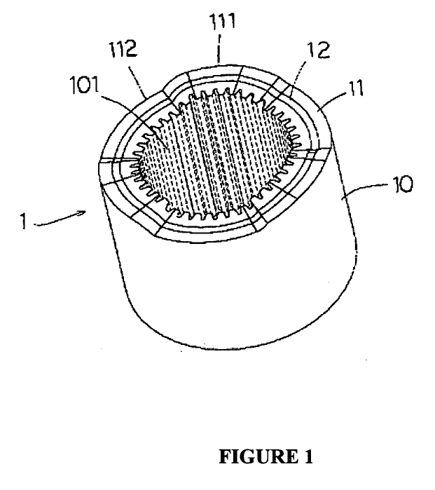

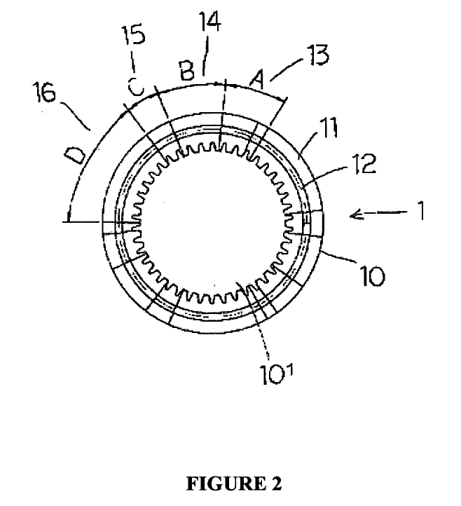

The improved cam mechanism as provided in this invention is both suitable for the electric and pneumatic screwdriver. As shown in FIG. 1, the cam mechanism (1) contains the body (10) and the shaft groove (101). The orbital surface (11) of the body (10) is divided into three segments, each segment contains a cyclic stroke from the top dead point (111) to the bottom dead point (112) and each stroke comprises four phases as shown in the FIG. 2.

Phase A (13) is employed to control the torque required for the electric or the pneumatic screwdriver. The stroke is designed with an outer R angle, differing from the general slant angle, so the axial reaction generated differs from that of the slant angle. In the slant angle design, the axial moment and the radical moment are 50% to 50%, that is to say 50% vibration generated in the start must be absorbed by the arm of the operator. In the outer R angle design, the axial moment amounts 25& and the radical moment, 75% which is absorbed by the spring, only 25& is absorbed by arm of the operator. Comparatively, the vibration generated in outer R angle design of the phase A (13) is 25% less than the slant angle design.

Phase B (14), a race stroke. The main purpose is to slow down the interchanging frequency between the top dead point (111) and the bottom dead point (112) on the orbital surface (11) of the cam body (10) so as to minimize the uncomforting the operator fells on the vibration frequency.

Phase C (15) is a stroke falling from the top dead point (111) to the bottom dead point (112) of the clutch. Compare with the general cam mechanism (1) in slant angle even no design of this stroke. Fast return will produce considerably large reciprocate vibration. The main purpose of the phase C is to alleviate the up and down reciprocates vibration of the clutch.

Phase D (16) is a continuity of the phase C (15) when the falling from the top dead point (111) to the bottom dead point (112), the cam body (10) walks half way of the reciprocate stroke, that means half reciprocate vibration is eliminated, a great cost saving in the production of the single direction bearing.

In addition, the orbital surface (11) of the body (10) provides the curved recess (12) for the catch ball to move on, which will enlarge the friction area between the cam body (10) and the catch ball, a means to elongate the service life of the cam mechanism (1).

The cam mechanism (1) is designed to gain the precise control of the preset torque required for tightening bolt. The catch ball will move from the phase A (13), to the phase B (14), the phase C (15) and the phase D (16) along the orbital surface (11) of the cam body (10).

The delicate design with the phase A (13), the phase B (14), the phase C (115) and the phase D (16) of the cam mechanism (1) is to gain the proper control over the preset torque requirement. The phase A (13) is designed to reduce the vibration to the minimum in the startup; The phase B (14) is designed to cut down the vibration frequency; the phase C (15) is designed to alleviate the up and down reciprocate vibration of the clutch; and the phase D (16) is designed to provide both directional rotations so as to save the cost in the special bearing.

It is learned that the improved cam mechanism for the low vibration screwdriver is comparatively a novel and outstanding improvement, not published before, justified for a grant of a patent.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An improved cam mechanism for the low vibration air-driven screwdriver contains a cam body and a shaft groove. The orbital surface of the cam body is divided into three segments and each segment comprises the cyclic stroke from the top dead point to the bottom dead point. Each stroke consists of four phases as described below:
Phase A, rising from the bottom dead point to the top dead point for controlling the required torque. Designed with outer R angle which will produce the axial moment 25% and the radical moment 75%.
Phase B, a race stroke moving to the top dead point in an effort to slow down the fast interchange frequency between the top dead point and the bottom dead point.
Phase C, falling from the top dead point to the bottom dead point to alleviate the up and down reciprocate vibration.
Phase D, a displacement to the top dead point, continued from phase C. the main purpose is to alleviate the up and down reciprocate vibration of the clutch. The other purpose is to save the installation of the special bearing which is very expensive.

2. The improved cam mechanism of this invention as claimed in the claim 1 in which the orbital surface on the cam body provides the curved recess for the catch ball so as to increase the friction area between the catch ball and the cam body and to elongate the service life of cam mechanism.
